(19) United States
(12) Patent Application Publication
(10) Pub. No.: US 2003/0130433 A1
(43) Pub. Date: Jul. 10, 2003

(54) Process for the production of graft polymers

(76) Inventors: Eckhard Wenz, Koln (DE); Vera Buchholz, Koln (DE); Herbert Eichenauer, Dormagen (DE); Udo Wolf, Kempen (DE); Ralf-Jurgen Born, Langenfeld (DE); Ulrich Jansen, Dormagen (DE); Wolfgang Dietz, Krefeld (DE)

Correspondence Address: BAYER POLYMERS LLC, 100 BAYER ROAD, PITTSBURGH, PA, 15205, US

(21) Appl. No.: 10/281,345

(22) Filed: Oct. 28, 2002

(30) Foreign Application Priority Data
Oct. 30, 2001 (DE) 10153534.1
Feb. 4, 2002 (DE) 10204393.0

(51) Int. Cl. C08F 279/00; C08F 255/06

(52) U.S. Cl. 525/313; 525/316

(57) ABSTRACT

A process of preparing a graft polymer (e.g., an ABS graft copolymer), which involves determining the concentration of at least one reaction component during the course of the reaction by means of Raman spectroscopy, is disclosed. The process, more particularly, comprises: (a) synthesizing the graft polymer from a reaction mixture comprising reactive components (e.g., monomers such as styrene and acrylonitrile, and a graft base); (b) analyzing the reaction mixture, at intervals, during the synthesis of the graft polymer, by means of Raman spectra; (c) recording the results of the Raman spectra analysis; (d) determining the concentration of at least one of said reactive components (e.g., styrene) by means of spectral evaluation of the recorded Raman spectra; and (e) terminating the synthesis reaction of the graft polymer when the concentration of at least one of the reactive components has reached a predetermined concentration value.

### CROSS REFERENCE TO RELATED PATENT APPLICATION

The present patent application claims the right of priority under 35 U.S.C. §119 (a)-(d) of German Patent Application No. 101 53 534.1, filed Oct. 30, 2001.

### DESCRIPTION OF THE INVENTION

The present invention relates to a process for the production of graft polymers (e.g., of the ABS type) with an improved ratio of monomer conversion to mechanical property level, which is achieved by terminating the reaction when the optimum monomer conversion is reached. The monomer conversion is determined by means of Raman spectroscopy.

Graft polymers of the ABS type are known (e.g., Ullmann's Encyclopedia of Industrial Chemistry, vol. A21, VCH Weinheim, 1992). These graft polymers can be produced, for example, by polymerisation in solution or by the so-called bulk process as well as by polymerisation in the presence of water (e.g., emulsion polymerisation, suspension polymerisation).

The term “graft polymers of the ABS type” originally denoted a polymer primarily constructed from acrylonitrile, butadiene and styrene. For the purpose and scope of this specification, this definition has been expanded to include polymer resins in which these components have been replaced in whole or in part by similar analogous compounds. Exemplary of analogous compounds of acrylonitrile are methacrylonitrile, ethacrylonitrile, and the like; exemplary of analogous compounds of styrene are alpha-methyl styrene chlorostyrene, vinyl toluene and the like; exemplary of analogous compounds of butadiene is isoprene, and the like.

In principle, when producing graft polymers of the ABS type, it is desirable to achieve as high a monomer conversion as possible, since this makes complex separation of unreacted monomers unnecessary and the process more economical.

Processes to achieve as high a monomer conversion as possible are known and involve, for example, the use of larger quantities of initiator, longer reaction times or the use of additional additives having an activating effect (cf. e.g. DE-A 19 74 11 88, WO 00/12569 and WO 00/14123 and the literature cited there).

It has been found, however, that the mechanical properties of graft polymers of the ABS type can be drastically impaired when a certain monomer conversion, generally above about 95%, is exceeded.

For the purpose of achieving an optimum balance of monomer conversion and mechanical properties of the product graft polymer, it is necessary to be able to monitor the monomer conversion sufficiently accurately and as closely timed as possible, preferably in real time, to be able to terminate the reaction in precisely the optimum state. The processes known from the prior art are not able to do this. In these processes the procedure involves terminating the graft polymerisation after a specific period, keeping as many parameters as possible constant. At an industrial level, however, the maintaining of the process parameters (such as e.g. temperature, monomer feed profile, pressure etc.) is no guarantee of the absolute reproducibility of the process and of obtaining products with pre-determined properties. The profile of the rate of reaction can be influenced by many factors, such as impurities retained in the reactants, variations in the rate of agitation, the surface finish of the reaction vessel, variations in the particle size, etc. This leads to the result that different reactions typically have different conversions at the same point in time. To avoid the occurrence of a sudden impairment of the mechanical properties of the products, it has been necessary up to now to terminate the reaction after a specific period, maintaining a certain safety margin, and thus to accept variations in the product properties and, in many cases, too low a monomer conversion, with the aforementioned disadvantages.

The object therefore existed of developing a process for the production of graft polymers that makes it possible to achieve an optimum of monomer conversion and mechanical property level. The optimum of monomer conversion and mechanical properties means in the context of the present invention the highest monomer conversion possible (i.e. even above 95%) without a substantial decrease in mechanical properties. In particular, the object existed of developing a process that makes it possible to achieve this optimum repeatedly and reproducibly once it has been found.

For an improved process, the most relevant polymerisation indicators possible must be available, preferably those indicators that can actually be measured during the process rather than only after the process, in order to be able to monitor the achievement of optimum monomer conversion. A method of in-process monitoring of the polymerisation is therefore needed.

One disadvantage of the known monitoring of the progress of the reaction by gas-chromatographic or infrared-spectroscopic investigation (cf. ASTMD 5670-95) of samples taken from the reactor lies in the fact that it generally takes 20 to 30 minutes for the analytical result to be available. In this period the reaction may have already progressed beyond the desired point.

It has now been found that in-process monitoring of this type can be performed by Raman-spectroscopic investigation of the reaction mixture of a graft polymerisation and evaluation of the Raman spectra obtained by chemometric methods.

WO 00/49395 discloses a process for the emulsion polymerisation of vinylic monomers, wherein reaction parameters are regulated as a function of the intensity of specific Raman spectral lines, so that the deviation between the measured process data and the reference data is minimised.

The above methods of evaluation are often unsuitable for industrial conversion, however, since they require a great deal of complex calibration. Furthermore, no criterion is mentioned for the termination of the reaction.

In accordance with the present invention, there is provided a process of preparing a graft polymer, comprising:

(a) synthesizing said graft polymer from a reaction mixture comprising reactive components (e.g., at least one radically polymerizable monomer and at least one graft base);

(b) analyzing, at intervals (e.g., brief intervals), during the synthesis of said graft polymer, said reaction mixture by means of Raman spectra;

(c) recording the results of the Raman spectra analysis;

(d) determining the concentration of at least one of said reactive components (and/or optionally at least one reaction product or co-product, e.g., polyacrylonitrile or polystyrene) by means of spectral evaluation of the recorded Raman spectra; and

(e) terminating the synthesis reaction of said graft polymer when the concentration of at least one of said reactive components (and/or optionally at least one reaction product or co-product) has reached a predetermined concentration value.

In accordance with the present invention, there is further provided a process of preparing a graft polymer as described above, which further comprises calculating a conversion value of at least one of said reactive components (e.g., a monomer conversion value) from, (i) the concentration value of said reactive component determined in step (d), and (ii) an initial concentration value of said reactive component; and terminating said synthesis reaction when the conversion value of said reactive component has reached a predetermined conversion value (e.g., a conversion value of 95% to 100%). For purposes of illustration, the conversion of a reactive component (e.g., styrene) may be determined with reference to the following equation:

{{(styrene)₀−(styrene)ₜ}/(styrene)₀}×100

In the above equation: (styrene)₀ represents the initial concentration of styrene at the beginning of the synthesis reaction; and (styrene)ₜ represents the concentration of styrene at a time “t” during the course of the reaction, as determined in step-(d) of the above process.

As used herein and in the claims, the term “analyzing, at intervals,” in step-(b), refers to analyzing the reaction mixture at least two separate times during the course of the synthetic reaction. In an embodiment of the present invention, the analysis of step (b) is performed at brief intervals, e.g., at intervals that are brief relative to the total time of the synthetic reaction, such as every hour, 30 minutes, 15 minutes, 10 minutes, 5 minutes, 2 minutes or every minute.

The features that characterize the present invention are pointed out with particularity in the claims, which are annexed to and form a part of this disclosure. These and other features of the invention, including its operating advantages will be more fully understood from the following detailed description and the accompanying drawing.

Other than in the examples, or where otherwise indicated, all numbers or expressions, such a those expressing structural dimensions, etc, used in the specification and claims are to be under stood as modified in all instances by the term “about.”

### BRIEF DESCRIPTION OF THE DRAWING FIGURE

FIG. 1 is a graphical representation of the quantities of reaction components, including reactive components and products or co-products, plotted as a function of time as determined by means of spectral evaluation of Raman spectra recorded during the course of a graft polymerization reaction described in further detail in the Examples herein.

### DETAILED DESCRIPTION OF THE INVENTION

The recording of these spectra can be performed offline, online or inline. In the context of the present invention, offline means that an aliquot of the reaction mixture is taken and measured in a separate place. Online refers to a procedure in which part of the reaction mixture is branched off from the reaction vessel, e.g. through a side loop, measured and then added to the reaction mixture again. Inline means that the measurement takes place directly in the reaction vessel. In the context of the present invention, the data recording preferably takes place online or inline.

The recording of the data to determine the monomer conversion takes place by Raman spectroscopy. The majority of the Raman spectrometer systems commercially available today can substantially be divided into two groups: Fourier transform and dispersive Raman spectrometers.

In Fourier transform Raman spectrometers, the excitation of the Raman spectrum takes place with the aid of an Nd:YAG laser (λ=1.06 μm). To detect the Raman radiation, an interferometer with near infrared optics is used. The non-wavelength-shifted Raleigh radiation is suppressed using a notch filter.

Since the intensity of the Raman radiation is proportional to 1/λ⁴, the relatively long-wave excitation using the Nd:YAG laser is initially unfavourable. However, since on the one hand Nd:YAG lasers are available with relatively high power (typically several Watts) and, in addition, the fluorescence that very often causes problems with excitation in the UV/VIS range does not occur, Raman spectra of organic substances can generally be recorded without any problems.

In the case of dispersive Raman spectrometers, on the other hand, the Raman radiation can be excited with various lasers. The use of He—Ne lasers (λ=632 nm) and semiconductor lasers (e.g. λ=785 nm) is conventional.

The breakdown of spectra and detection take place with the aid of a grating and a (thermoelectrically cooled) CCD detector. The Raleigh scattered radiation is blocked with the aid of a notch filter. These systems can be operated particularly simply in multiplex operation, since several spectra can be mapped on the junction-type CCD detector simultaneously and read out consecutively.

The spectral sensitivity of different Raman spectrometers is not the same. Calibrations can therefore only be transferred to different spectrometers to a limited extent. The calibration factors should therefore be checked and adjusted when transferring to another spectrometer.

Other influences on the spectral sensitivity are possible from the medium to be analysed itself, as this can absorb radiation. The Stokes-shifted Raman spectrum (fundamental vibration range) is located in the range ν₀ to ν₀-4000 cm⁻¹, i.e. in the case of excitation with the Nd:YAG laser in the range of 9400-5400 cm⁻¹. In this spectral range, water possesses not insignificant absorption. In emulsion polymerisation, the effective path length of the Raman radiation in the sample can depend on the (variable) scattering properties of the emulsion. The relative intensity ratios of the Raman spectrum thus also depend on the emulsion properties. However, this only applies to the range ν>2000 cm⁻¹ of the Raman spectrum for excitation with the Nd:YAG laser. In the case of excitation with the 785 nm semiconductor laser, the Raman radiation (fundamental vibrations) is in the range of 12700-8700 cm⁻¹. In this spectral range the inherent absorption of the medium to be analysed (e.g. water) is generally much weaker. Accordingly, the influence of the emulsion properties on the Raman spectrum is smaller.

The laser radiation used to excite the Raman spectrum can be polarised or non-polarised. On the detection side, a polariser can optionally be used to exclude any undesired polarisation directions. Between the exciting laser beam and detection optics, there can be an angle of between 0 and 360°, preferably 90 to 180°.

The recording of the Raman spectra can preferably take place by fibre-optic coupling. By using probe optics (e.g. Raman measuring head, Bunker, Karlsruhe), the Raman spectra of the contents of a reactor can be measured through an inspection glass fitted to the reactor. In addition, immersion probes are also available, which are in direct contact with the product to be analysed and which are connected to a Raman spectrometer by fibre-optic light guides.

The frequency of the measurements recorded depends on the rate of process data flow. For example, recordings take place at intervals of 1 second to 30 minutes, preferably 10 seconds to 10 minutes.

The spectra obtained may be evaluated by chemometric methods. For example, the data obtained are compared with previously obtained reference data. These reference data are determined from tests that have given a graft polymer with the desired properties. When the desired data are achieved, the reaction is terminated by suitable measures and the graft polymer isolated in a known manner.

Suitable measure for terminating the graft polymerization reaction, include for example, cooling the reaction mixture and/or adding a radical interceptor, such as diethylhydroxylamine (DEHA), to the reaction mixture.

Basic chemometric processes are described, for example, in “Analytische Chemie,” author: G. Schwedt, Georg Thieme Verlag Stuttgart New York, 1995.

In a preferred embodiment of the present invention, the graft polymer is prepared from (i.e., the reaction mixture comprises):

A.1 5 to 95, preferably 30 to 90 wt. % of at least one vinyl monomer is polymerised in the presence; and

A.2 95 to 5, preferably 70 to 10 wt. % of one or more backbones (or graft bases), each having a glass transition temperature value of <10° C., preferably <0° C., particularly preferably less than −20° C.

In an embodiment of the present invention, the vinyl monomers A.1 are composed of a mixture of:

A.1.1 50 to 99 parts by weight of vinyl aromatics and/or ring-substituted vinyl aromatics (e.g., styrene, α-methylstyrene, p-methylstyrene, p-chlorostyrene) and/or alkyl (C₁-C₈) methacrylates (such as methyl methacrylate, ethyl methacrylate); and

A.1.2 1 to 50 parts by weight of vinyl cyanides (unsaturated nitriles such as acrylonitrile and methacrylonitrile) and/or alkyl (C₁-C₈) (meth)acrylates (such as methyl methacrylate, n-butyl acrylate, t-butyl acrylate) and/or derivatives (such as anhydrides and imides) of unsaturated carboxylic acids (e.g. maleic anhydride and N-phenylmaleimide).

The vinyl monomers A.1.1 and A.1.2 are preferably different, one from the other.

Preferred monomers A.1.1 are selected from at least one of the monomers styrene, α-methylstyrene and methyl methacrylate; preferred monomers A.1.2 are selected from at least one of the monomers acrylonitrile, maleic anhydride and methyl methacrylate.

Particularly preferred monomers are A.1.1 styrene and A.1.2 acrylonitrile.

Suitable backbones A.2 include, for example, diene rubbers, EP(D)M rubbers (i.e., those based on ethylene/propylene and optionally diene), acrylate, polyurethane, silicone, chloroprene and ethylene/vinyl acetate rubbers and mixtures thereof.

Suitable acrylate rubbers according to A.2 are preferably polymers of alkyl acrylates, optionally with up to 40 wt. %, based on A.2, of other polymerisable, ethylenically unsaturated monomers. The preferred polymerisable acrylates include C₁-C₈ alkyl esters, e.g., methyl, ethyl, butyl, n-octyl and 2-ethylhexyl esters; haloalkyl esters, preferably halo-C₁-C₈-alkyl esters, such as chloroethyl acrylate, and mixtures of these monomers.

Preferred other polymerisable, ethylenically unsaturated monomers, which can optionally be used to produce the backbone A.2 apart from the acrylates include, for example, acrylonitrile, styrene, α-methylstyrene, acrylamides, vinyl C₁-C₆ alkyl ethers, methyl methacrylate and butadiene. Preferred rubbers as backbone A.2 are emulsion polymers having a gel content of at least 30 wt. %.

In the production of acrylate rubbers, monomers with more than one polymerisable double bond can be copolymerised for crosslinking. Preferred examples of crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, such as ethylene glycol dimethacrylate, allyl methacrylate; polyunsaturated heterocyclic compounds, such as trivinyl cyanurate and triallyl cyanurate; polyfunctional vinyl compounds, such as di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least three ethylenically unsaturated groups.

Particularly preferred crosslinking monomers are the cyclic monomers triallyl cyanurate, triallyl isocyanurate, triacryloylhexahydro-s-triazine and triallylbenzenes. The quantity of the crosslinked monomers is preferably 0.02 to 5, particularly 0.05 to 2 wt. %, based on the backbone A.2.

In the case of cyclic crosslinking monomers with at least three ethylenically unsaturated groups, it is advantageous to limit the quantity to less than 1 wt. % of the backbone A.2.

Other suitable backbones according to A.2 are silicone rubbers with graft-linking points, as described in DE-A 37 04 657, DE-A 37 04 655, DE-A 36 31 540 and DE-A 36 31 539.

Preferred backbones A.2 are diene rubbers (e.g., based on butadiene, isoprene etc.) or mixtures of diene rubbers or copolymers of diene rubbers or mixtures thereof with other copolymerisable monomers (e.g. according to A.1.1 and A.1.2), with the proviso that the glass transition temperature of component A.2 is below <10° C., preferably <0° C., particularly preferably <−10° C.

Pure polybutadiene rubber is particularly preferred.

The gel content of the backbone A.2 is determined at 25° C. in a suitable solvent (M. Hoffmann, H. Krömer, R. Kuhn, Polymeranalytik I and II, Georg Thieme-Verlag, Stuttgart 1977). The gel content of the backbone A.2 is at least 30 wt. %, preferably at least 40 wt. % (measured in toluene).

In the case of emulsion or suspension polymerisation, the backbone A.2 generally has an average particle size (d₅₀ value) of 0.05 to 10 μm, preferably 0.1 to 5 μm and particularly preferably 0.2 to 1 μm.

The average particle size d₅₀ is the diameter which 50 wt. % of the particles lie above and 50 wt. % below. It can be determined by ultracentrifuge measurement (W. Scholtan, H. Lange, Kolloid, Z. und Z. Polymere 250 (1972), 782-796).

The graft copolymers are produced by free-radical polymerisation, for example, by emulsion, suspension, solution or bulk polymerisation, preferably by emulsion or suspension polymerisation and particularly preferably by emulsion polymerisation.

The graft polymerisation can be performed by any processes, and is preferably performed in that the monomer mixture A.1 is continuously added to the backbone A.2 and polymerised.

Special monomer/rubber ratios are preferably maintained and the monomers added to the rubber in a known manner.

To produce the graft polymers according to the invention, the graft polymerisation can, for example, be performed in such a way that, within the first half of the total monomer addition period, 55 to 90 wt. %, preferably 60 to 80 wt. % and particularly preferably 65 to 75 wt. % of the total monomers to be used in the graft polymerisation are metered in; the remaining portion of monomers is metered in within the second half of the total monomer addition period.

Conventional anionic emulsifiers, such as alkyl sulfates, alkyl sulfonates, aralkyl sulfonates, soaps of saturated or unsaturated fatty acids and of alkaline disproportionated or hydrogenated abietic or tall oil acids can be used as emulsifier. In principle, emulsifiers with carboxyl groups (e.g. salts of C₁₀-C₁₈ fatty acids, disproportionated abietic acid and emulsifiers according to DE-A 36 39 904 and DE-A 39 13 509) can also be used.

In addition, molecular weight regulators can be used during the graft polymerisation, preferably in quantities of 0.01 to 2 wt. %, particularly preferably in quantities of 0.05 to 1 wt. % (based on the total quantity of monomers in each case). Suitable molecular weight regulators are e.g. alkyl mercaptans, such as n-dodecyl mercaptan, t-dodecyl mercaptan; dimeric α-methylstyrene; terpinolene.

Inorganic and organic peroxides, such as H₂O₂, di-tert.-butyl peroxide, cumene hydroperoxide, dicyclohexyl percarbonate, tert.-butyl hydroperoxide, p-menthane hydroperoxide, azo initiators, such as azobisisobutyronitrile, inorganic per salts, such as ammonium, sodium or potassium persulfate, potassium perphosphate, sodium perborate and redox systems are suitable as initiators.

Redox systems generally consist of an organic oxidising agent and a reducing agent, with heavy metal ions possibly also present in the reaction medium (cf. Houben-Weyl, Methoden der Organischen Chemie, vol.14/1, p. 263 to 297).

The polymerisation temperature is generally between 25° C. and 160° C., preferably between 40° C. and 90° C.

It is possible to work according to conventional temperature control, e.g. isothermally; preferably, however, the graft polymerisation is performed in that the temperature difference between the beginning and end of the reaction is at least 10° C., preferably at least 15° C. and particularly preferably at least 20° C.

Graft copolymers that are particularly preferably obtainable by the process according to the invention are ABS polymers (emulsion, bulk and suspension ABS), as described, for example, in DE-A 20 35 390 (=U.S. Pat. No. 3,644,574) or in DE-A 22 48 242 (=GB-A 1 409 275) and in Ullmanns, Enzyklopädie der Technischen Chemie, vol.19 (1980), p. 280 ff.

Particularly suitable graft copolymers are also ABS polymers produced by persulfate initiation or by redox initiation with an initiator system consisting of organic hydroperoxide and ascorbic acid according to U.S. Pat. No. 4,937,285.

During the graft polymerisation, Raman spectra of the reactor contents are recorded at brief intervals in the range of νₘᵢₙ=−4000 cm⁻¹ (anti-Stokes region) and νₘₐₓ=4000 cm⁻¹ (Stokes region), preferably νₘᵢₙ=500 cm⁻¹ and νₘₐₓ=2500 cm⁻¹, particularly preferably νₘᵢₙ =750 cm⁻¹ and νₘₐₓ=1800 cm⁻¹, and the factors f_{I}, are calculated (weighted subtraction) from the Raman spectra, previously measured and stored in digitised form in an electronic data processing unit, i_{PB}(ν) of polybutadiene (PB), I_{PS}(ν) of polystyrene (PS), I_{PAN}(ν) of polyacrylonitrile (PAN), I_{STY}(ν) of styrene (STY) and I_{ACN}(ν) of acrylonitrile (ACN) and the current spectrum I(ν) of the reactor contents from the condition

$${{\sum }_{v min}}^{v max} {\{ {l}_{K} ( v ) - [ {f}_{PB} * {l}_{PB} ( v ) + {f}_{PS} * {l}_{PS} ( v ) + {f}_{PAN} * {l}_{PAN} ( v ) + {f}_{STY} * {l}_{STY} ( v ) + {f}_{ACN} * {l}_{ACN} ( v ) + {f}_{k} ] \}}^{2} = minimum ,$$

wherein the summation takes place over all the data points of the spectra Iᵢ(ν) digitised in the same form.

From this, the quotients

Q_{PS}=f_{PS}/f_{PB}, Q_{PAN}=f_{PAN}/f_{PB}, Q_{STY}=f_{STY}/f_{PB} and Q_{ACN}=f_{ACN}/f_{PB}

and, using the previously determined calibration factors K, the quantitative proportions W of:

polystyrene to polybutadiene: W_{PS}=K_{PS}* Q_{PS}

polyacrylonitrile to polybutadiene: W_{PAN}=K_{PAN}* Q_{PAN}

styrene to polybutadiene: W_{STY}=K_{STY}* Q_{STY}

acrylonitrile to polybutadiene: W_{ACN}=K_{ACN}* Q_{ACN}

are calculated and, from these, according to:

M_{PS}=W_{PS}*M_{PB}, M_{PAN}=W_{PAN}*M_{PB}, M_{STY}=W_{STY}*M_{PB} and M_{ACN}=W_{ACN}*M_{PB}

the absolute quantities of polystyrene M_{PS}, polyacrylonitrile M_{PAN}, styrene M_{STY}, and acrylonitrile M_{ACN} in the reactor are determined.

When the desired monomer conversion is reached, particularly a desired styrene content, the reaction is terminated by known methods and the product (the graft copolymer) is isolated.

In a particularly preferred embodiment, the factors K_{PS}, K_{PAN}, K_{STY}, and K_{ACN} are determined in a calibration step in that the Raman spectra I_{K}(ν) of mixtures with known quantitative proportions are recorded. From the condition:

$${{\sum }_{v min}}^{v max} {\{ {l}_{K} ( v ) - [ {f}_{PB} * {l}_{PB} ( v ) + {f}_{PS} * {l}_{PS} ( v ) + {f}_{PAN} * {l}_{PAN} ( v ) + {f}_{STY} * {l}_{STY} ( v ) + {f}_{ACN} * {l}_{ACN} ( v ) + {f}_{k} ] \}}^{2} = minimum ,$$

wherein the factors fᵢ are calculated, from these the quotients

Q_{PS}=f_{PS}/f_{PB}, Q_{PAN}=f_{PAN}/f_{PB}, Q_{STY}=f_{STY}/f_{PB} and Q_{ACN}=f_{PAN}/f_{PB} are determined,

from the known quantities M the parts by weight W

W_{PS}=M_{PS}/M_{PB}, W_{PAN}=M_{PAN}/M_{PB}, W_{STY}=M_{STY}/M_{PB} and W_{ACN}=M_{ACN}/M_{PB},

and according to the equations

K_{PS}=W_{PS}/Q_{PS}, K_{PAN}=W_{PAN}/Q_{PAN}, K_{STY}=W_{STY}/Q_{STY} and K_{ACN}=W_{ACN}/Q_{ACN},

the calibration factors K are calculated.

The graft polymers prepared by the process according to the invention display a constant, optimum ratio of the lowest possible residual monomer content and, at the same time, excellent mechanical properties, such as high impact strength.

The graft polymers are conventionally blended with rubber-free resin components after they have been isolated.

Copolymers of styrene and acrylonitrile in a weight ratio of 95:5 to 50:50 are preferably used as rubber-free resin components, styrene and/or acrylonitrile optionally being replaced completely or partially by α-methylstyrene, methyl methacrylate or N-phenylmaleimide. Those copolymers having proportions of incorporated acrylonitrile units of less than 30 wt. % are particularly preferred.

These copolymers preferably possess weight-average molecular weights \overline{M}w of 20 000 to 200 000 or intrinsic viscosities [η] of 20 to 110 ml/g (measured in dimethyl formamide at 25° C.).

Details of the production of these copolymers are described e.g. in DE-A 24 20 358 and DE-A 27 24 360. Vinyl resins produced by bulk or solution polymerisation have proved particularly suitable. The copolymers can be added alone or in any mixture.

Apart from thermoplastic resins built up from vinyl monomers, the use of polycondensates, e.g. aromatic polycarbonates, aromatic polyester carbonates, polyesters and polyamides as rubber-free resin components in the moulding compositions according to the invention is also possible.

Suitable thermoplastic polycarbonates and polyester carbonates are known (cf. e.g. DE-A 14 95 626, DE-A 22 32 877, DE-A 27 03 376, DE-A 27 14 544, DE-A 30 00 610, DE-A 38 32 396, DE-A 30 77 934), which can be produced, for example, from diphenols represented by the following formulas (I) and (II):

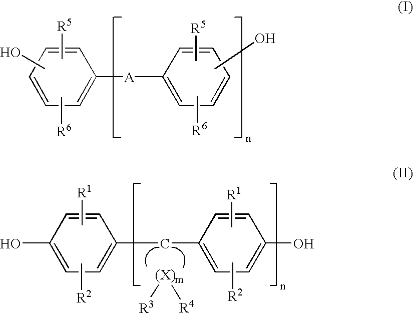

wherein

A is a single bond, C₁-C₅ alkylene, C₂-C₅ alkylidene, C₅-C₆ cycloalkylidene, —O—, —S—, —SO—, —SO₂— or —CO—,

R⁵ and R⁶, independently of one another, denote hydrogen, methyl or halogen, particularly hydrogen, methyl, chlorine or bromine,

R¹ and R², independently of one another, denote hydrogen, halogen, preferably chlorine or bromine, C₁-C₈ alkyl, preferably methyl, ethyl, C₅-C₆ cycloalkyl, preferably cyclohexyl, C₆-C₁₀ aryl, preferably phenyl, or C₇-C₁₂ aralkyl, preferably phenyl-C₁-C₄-alkyl, particularly benzyl,

m is an integer from 4 to 7, preferably 4 or 5,

n is 0 or 1,

R³ and R⁴ are selected for each X individually and, independently of one another, signify hydrogen or C₁-C₆ alkyl, and

X signifies carbon,

In the preparation of the thermoplastic polycarbonate, diphenols, such as those represented by Formulas (I) and (II) may be reacted with carbonic acid halides, preferably phosgene, and/or with aromatic dicarboxylic acid dihalides, preferably benzenedicarboxylic acid dihalides, by interfacial polycondensation or with phosgene by polycondensation in the homogeneous phase (the so-called pyridine process). It is possible to adjust the molecular weight of the thermoplastic polycarbonate by known means using an appropriate quantity of known chain terminators (e.g., monofunctional phenols).

Suitable diphenols of formulae (I) and (II) include, for example, hydroquinone, resorcinol, 4,4′-dihydroxydiphenyl, 2,2-bis(4-hydroxyphenyl)propane, 2,4-bis(4-hydroxyphenyl)-2-methylbutane, 2,2-bis(4-hydroxy-3,5-dimethylphenyl)propane, 2,2-bis(4-hydroxy-3,5-dichlorophenyl)propane, 2,2-bis(4-hydroxy-3,5-dibromophenyl)propane, 1,1-bis(4-hydroxyphenyl)cyclohexane, 1,1-bis(4-hydroxyphenyl)-3,3,5-trimethylcyclohexane,1,1-bis(4-hydroxyphenyl)-3,3-dimethylcyclohexane, 1,1-bis(4-hydroxyphenyl)-3,3,5,5-tetramethylcyclohexane or 1,1-bis(4-hydroxyphenyl)-2,4,4-trimethylcyclopentane.

Preferred diphenols of formula (I) are 2,2-bis(4-hydroxyphenyl)-propane and 1,1-bis(4-hydroxyphenyl)cyclohexane, and the preferred phenol of formula (II) is 1,1-bis(4-hydroxyphenyl)-3,3,5-trimethylcyclohexane. Mixtures of diphenols can also be used.

Suitable chain terminators include, for example, phenol, p-tert.-butylphenol, long-chained alkylphenols, such as 4-(1,3-tetramethylbutyl)-phenol according to DE-A 28 42 005, monoalkylphenols, dialkylphenols with a total of 8 to 20 C atoms in the alkyl substituents according to DE-A 35 06 472, such as p-nonylphenol, 2,5-di-tert.-butylphenol, p-tert.-octylphenol, p-dodecylphenol, 2-(3,5-dimethylheptyl)phenol and 4-(3,5-dimethylheptyl)phenol. The required quantity of chain terminators is generally 0.5 to 10 mole %, based on the sum of the diphenols (I) and (II).

The suitable polycarbonates or polyester carbonates can be linear or branched; branched products are preferably obtained by incorporating 0.05 to 2.0 mole %, based on the sum of the diphenols used, of trifunctional or more than trifunctional compounds, e.g., those with three or more phenolic OH groups.

While suitable polycarbonates or polyester carbonates may contain aromatically bound halogen, preferably bromine and/or chlorine, they are preferably halogen-free.

Thermoplastic polycarbonates with which graft polymers of the present invention may be mixed, typically have average molecular weights (\overline{M}_{w}, weight average), determined, for example, by ultracentrifugation or light-scattering measurement, of 10 000 to 200 000, preferably of 20 000 to 80 000.

Suitable thermoplastic polyesters are preferably polyalkylene terephthalates, i.e., reaction products of aromatic dicarboxylic acids or their reactive derivatives (e.g., dimethyl esters or anhydrides) and aliphatic, cycloaliphatic or arylaliphatic diols and mixtures of these reaction products.

Preferred polyalkylene terephthalates can be produced from terephthalic acids (or their reactive derivatives) and aliphatic or cycloaliphatic diols with 2 to 10 C atoms according to known methods (Kunststoff-Handbuch, volume VIII, p. 695 ff, Carl Hanser Verlag, Munich 1973).

In preferred polyalkylene terephthalates, 80 to 100, preferably 90 to 100 mole % of the dicarboxylic acid groups are terephthalic acid groups and 80 to 100, preferably 90 to 100 mole % of the diol groups are ethylene glycol and/or 1,4-butanediol groups.

The preferred polyalkylene terephthalates can contain, in addition to ethylene glycol or 1,4-butanediol groups, 0 to 20 mole % of groups of other aliphatic diols with 3 to 12 C atoms or cycloaliphatic diols with 6 to 12 C atoms, e.g. groups of 1,3-propanediol, 2-ethyl-1,3-propanediol, neopentyl glycol, 1,5-pentanediol, 1,6-hexanediol, 1,4-cyclohexanedimethanol, 3-methyl-1,3- and -1,6-pentanediol, 2-ethyl- 1,3-hexanediol, 2,2-diethyl-1,3-propanediol, 2,5-hexanediol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane (DE-A 24 07 647, 24 07 776, 27 15 932).

The polyalkylene terephthalates can be branched by incorporating relatively small quantities of 3- or 4-hydric alcohols or tri- or tetrabasic carboxylic acids, as described in DE-A 19 00 270 and U.S. Pat. No. 3,692,744. Examples of preferred branching agents are trimesic acid, trimellitic acid, trimethylolethane, trimethylolpropane and pentaerythritol. It is advisable to use no more than 1 mole % of the branching agent, based on the acid component.

Polyalkylene terephthalates produced only from terephthalic acid and its reactive derivatives (e.g. its dialkyl esters) and ethylene glycol and/or 1,4-butanediol and mixtures of these polyalkylene terephthalates are particularly preferred.

Preferred polyalkylene terephthalates are also copolyesters produced from at least two of the above-mentioned alcohol components: particularly preferred copolyesters are poly(ethylene glycol-1,4-butanediol) terephthalates.

The preferably suitable polyalkylene terephthalates generally possess an intrinsic viscosity of 0.4 to 1.5 dl/g, preferably 0.5 to 1.3 dl/g, particularly 0.6 to 1.2 dl/g, measured in phenol/o-dichlorobenzene (1:1 parts by weight) at 25° C. in each case.

Suitable polyamides are known homopolyamides, copolyamides and mixtures of these polyamides. These can be partially crystalline and/or amorphous polyamides. Polyamide-6, polyamide-6,6, mixtures and corresponding copolymers of these components are suitable as partially crystalline polyamides. In addition, partially crystalline polyamides, the acid component of which consists wholly or partly of terephthalic acid and/or isophthalic acid and/or suberic acid and/or sebacic acid and/or azelaic acid and/or adipic acid and/or cyclohexanedicarboxylic acid and the diamine component of which consists wholly or partly of m- and/or p-xylylenediamine and/or hexamethylenediamine and/or 2,2,4-trimethylhexa-methylenediamine and/or 2,4,4-trimethylhexamethylenediamine and/or isophorone diamine, and the composition of which is known in principle, are suitable.

Polyamides produced wholly or partly from lactams with 7-12 C atoms in the ring, optionally with the incorporation of one or more of the above-mentioned starting components, can also be mentioned.

Particularly preferred partially crystalline polyamides are polyamide-6 and polyamide-6,6 and mixtures thereof. Known products can be used as amorphous polyamides. They are obtained by polycondensation of diamines, such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbornane and/or 1,4-diaminomethylcyclohexane, with dicarboxylic acids, such as oxalic acid, adipic acid, azelaic acid, decanedicarboxylic acid, heptadecanedicairboxylic acid, 2,2,4- and/or 2,4,4-trimethyladipic acid, isophthalic acid and terephthalic acid.

Copolymers obtained by polycondensation of several monomers are also suitable, as are copolymers produced with the addition of aminocarboxylic acids, such as ε-aminocaproic acid, ω-aminoundecanoic acid or ω-aminolauric acid or the lactams thereof.

Particularly suitable amorphous polyamides are the polyamides produced from isophthalic acid, hexamethylenediamine and other diamines, such as 4,4′-diaminodicyclohexylmethane, isophorone diamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and ε-caprolactam; or from isophthalic acid, 3,3′-dimethyl-4,4′-diaminodicyclohexylmethane and laurolactam; or from terephthalic acid and the mixture of isomers of 2,2,4- and/or 2,4,4-trimethylhexamethylenediamine.

Instead of the pure 4,4′-diaminodicyclohexylmethane, mixtures of the positional isomers of diaminodicyclohexylmethane can also be used, which are composed of: 70 to 99 mole % of the 4,4′-diamino isomer;1 to 30 mole % of the 2,4′-diamino isomer; 0 to 2 mole % of the 2,2′-diamino isomer; and optionally correspondingly more highly condensed diamines, obtained by hydrogenation of technical-grade diaminodiphenylmethane. The isophthalic acid can be replaced by up to 30% terephthalic acid.

The polyamides preferably have a relative viscosity (measured in a 1 wt. % solution in m-cresol at 25° C.) of 2.0 to 5.0, particularly preferably 2.5 to 4.0.

The graft polymers according to the invention are suitable, preferably after blending with at least one rubber-free resin, for the production of moulded parts, e.g. for domestic appliances, vehicle components, office equipment, telephones, radio and television housings, furniture, pipes, leisure articles or toys.

The invention is illustrated below by means of examples.

### EXAMPLE

In the example, parts are parts by weight and percentages are wt. %, unless otherwise specified.

6516 g of rubber latex 1 (49.1% solids, 400 nm particle size) and 6573 g of rubber latex 2 (48.7% solids, 290 nm particle size) and 506.6 g of a 7.3% Dresinate® solution (sodium salt of disproportionated abietic acid, pH approximately 13) are placed in a steel autoclave. The initial charge is rendered inert with nitrogen and heated to 59° C.

According to the metering scheme given in Table 1, the following solutions are added:

TABLE 1

| Running | Soln. B | Soln. C | Soln. D | Soln. E | Soln. F |
|---|---|---|---|---|---|
| time [h] | [g/h] | [g/h] | [g/h] | [g/h] | [g/h] |
| 0-1 | 1215.2 | 151.3 | 251.6 | 730.1 | |
| 1-1.25 | 1215.2 | 151.3 | 251.6 | 625.8 | 7082.4 |
| 1.25-2 | 1215.2 | 151.3 | 251.6 | 625.8 | — |
| 2-3 | 1215.2 | 151.3 | 251.6 | 417.2 | — |
| 3-4 | 1215.2 | 151.3 | 251.6 | 312.9 | — |
| 4-5.4 | — | 151.3 | 251.6 | — | — |

Discharge 10 kg latex, shortstop with 100 g 25% DEHA

| | | | | | |
|---|---|---|---|---|---|
| 5.4-6.3 | — | 101.9 | 169.5 | — | — |

Discharge 10 kg latex, shortstop with 100 g 25% DEHA

| | | | | | |
|---|---|---|---|---|---|
| 6.3-7 | — | 52.5 | 187.3 | — | — |
| 7-9 | — | 104.5 | 174.5 | — | — |

Solution B: 3548.5 g styrene; 1312.4 g acrylonitrile
Solution C: 35.4 g tert-butyl hydroperoxide (80%); 351.5 g Dresinate solution; 767.6 g water
Solution D: 24.6 g sodium ascorbate; 1896.8 g water
Solution E: 1770 g water

The reaction mixture is heated uniformly from 59° C. to 85° C. with the start of the additions (time 0) to 4.5 h, at a rate of 0.0963° C./min. When the final temperature is reached, this is maintained at 85° C. until all the additions have been made. The reaction contents are then cooled to 25° C.

According to Table 1, 10 kg samples of latex are taken after 5.4 h (sample 1) and 6.3 h (sample 2) and 100 g of a 25% diethylhydroxylamine solution (DEHA) are added for the immediate termination of the reaction. After nine hours, the entire reaction is stopped by adding DEHA. To isolate the products (sample 1, sample 2, end product), the latex in question is coagulated with a magnesium sulfate/acetic acid mixture after adding about 1 wt. % of a phenolic antioxidant, and the resulting ABS powder is washed with water and then dried at 70° C.

The progress of the reaction is monitored online by Raman spectroscopy with the aid of a loop circulation, through which approx. 300 ml of the reaction mixture are continuously pumped. The sample circulation is returned to the reactor by means of a double-piston pump.

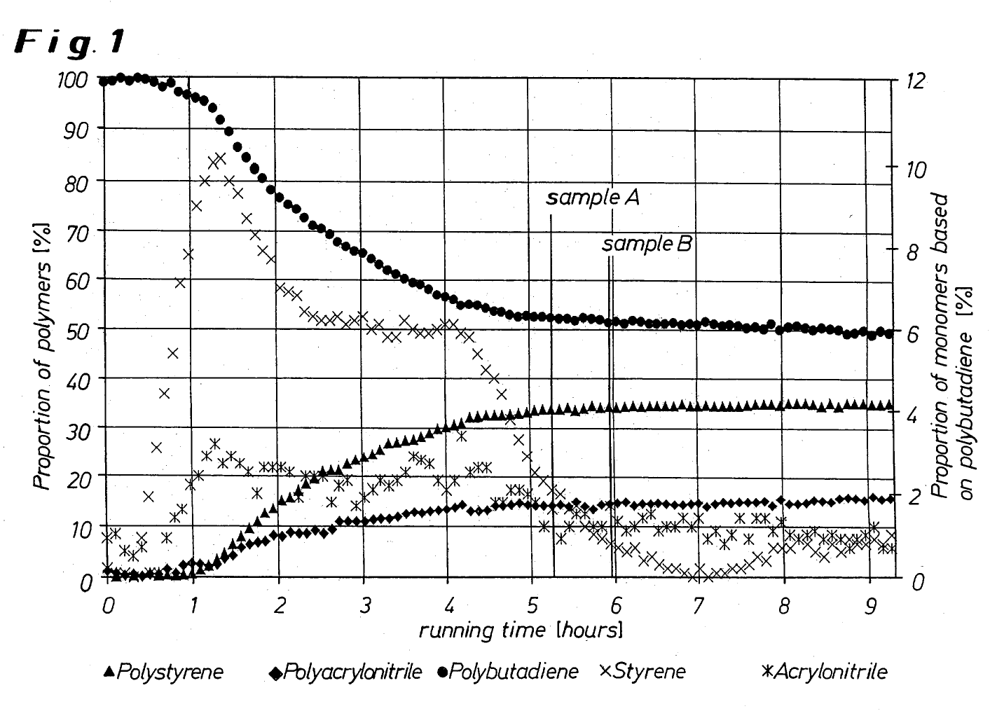

FIG. 1 shows the quantities of the components polybutadiene, polystyrene, polyacrylonitrile, styrene and acrylonitrile present in the reactor, calculated from the Raman spectra on the basis of the calibration described. The proportions of polymer add up to 100% (left-hand ordinate), while the proportions of monomer (in percent, right-hand ordinate) relate to the initial polybutadiene.

After completion of the monomer addition (4 hours), only small changes in the polymer composition are detected and a monotonic decrease in the quantity of monomeric styrene. At very low values (less than 1%, based on polybutadiene according to gas chromatography) the styrene content passes through an apparent minimum, according to Raman evaluation, and then increases slightly again. Owing to the reproducibility of this curve, however, the desired termination point can be determined exactly by Raman spectroscopy.

The residual monomer contents of the latex samples taken are determined by gas chromatography and are given in Table 2.

TABLE 2

| | Sample 1 | Sample 2 | End product |
|---|---|---|---|
| Styrene/ppm | 8800 | 4900 | 190 |
| Acrylonitrile/ppm | 420 | 290 | 28 |
| Conversion of styrene | 97.2% | 98.5% | 99.9% |

The powders are kneaded with the substances listed in Table 3 in a laboratory kneader and extruded into the appropriate mouldings at 260° C.

Makrolon® 2600 from Bayer is a linear, aromatic homopolycarbonate based on 2,2-bis(4-hydroxyphenyl)propane (bisphenol A).

The modulus of elasticity in tension is determined in accordance with DIN 53 457/ISO 527.

The melt volume-flow rate (MVR) is determined in accordance with DIN 53 753 at 260° C. and with a 5 kg load.

The elongation at break is determined in the context of the determination of the modulus of elasticity in tension according to ISO 527 on F3 dumbbell-shaped test pieces.

The brittle-tough transition is determined in accordance with ISO 180 1A on test pieces measuring 80×10×4 mm. The brittle-tough transition is the temperature at which the majority of the test pieces display brittle fracture behaviour (smooth fracture surfaces).

TABLE 3

| Formulation | A | B | C |
|---|---|---|---|
| Sample 1 | 24 | | |
| Sample 2 | | 24 | |
| End product | | | 24 |
| Makrolon ® 2600 | 43 | 43 | 43 |
| SAN (styrene/acrylonitrile copolymer 72:28) | 33 | 33 | 33 |
| Stabiliser | 0.14 | 0.14 | 0.14 |
| PETS (pentaerythritol tetrastearate) | 0.75 | 0.75 | 0.75 |
| Brittle-tough transition/° C. | −10/−20 | −10/−20 | 23 |
| Modulus of elasticity N/mm2 | 1944 | 1919 | 1943 |
| MVR/ccm/10 min | 9.4 | 9.7 | 12.6 |
| Elongation at break/% | 110.6 | 115 | 99.5 |

It can be seen clearly that the low-temperature toughness is at an approximately constant level (−10/−20° C.) up to a residual styrene content of 4900 ppm, while an undesirable brittle fracture already occurs at room temperature with a residual styrene content of 190 ppm. Other characteristic mechanical parameters, such as the MVR, the modulus and the elongation at break vary within the conventional experimental fluctuations.

The process according to the invention using online or inline Raman spectroscopy now makes it possible to terminate the following reactions at the point, once determined, for an ideal compromise between maintaining the mechanical properties and the lowest possible level of residual monomers.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process of preparing a graft polymer, comprising:
(a) synthesizing said graft polymer from a reaction mixture comprising reactive components;
(b) analyzing, at intervals, during the synthesis of said graft polymer, said reaction mixture by means of Raman spectra;
(c) recording the results of the Raman spectra analysis;
(d) determining the concentration of at least one of said reactive components by means of spectral evaluation of the recorded Raman spectra; and
(e) terminating the synthesis reaction of said graft polymer when the concentration of at least one of said reactive components has reached a predetermined concentration value.

2. The process of claim 1 wherein the Raman spectra analysis step (b) and the Raman spectra recording step (c) are each performed one of inline and online.

3. The process of claim 1 wherein the Raman spectra analysis is performed by means of a Fourier transform spectrometer.

4. The process of claim 1 wherein the Raman spectra analysis is performed by means of a dispersive spectrometer having a CCD detector.

5. The process of claim 1 wherein the Raman spectra analysis is performed by means of a Nd:YAG laser.

6. The process of claim 1 wherein the Raman spectra analysis is performed by means of a helium-neon laser.

7. The process of claim 1 wherein the Raman spectra analysis is performed by means of a semiconductor laser.

8. The process of claim 1 wherein the spectral evaluation of the recorded Raman spectra of step (d) is performed by means of a chemometric method.

9. The process of claim 1 wherein the spectral evaluation of the recorded Raman spectra of step (d) is performed by means of weighted spectral subtraction.

10. The process of claim 1 wherein the concentration of said reactive component is determined in step (d) by means of comparison of the recorded Raman spectra with previously obtained calibration values.

11. The process of claim 1 wherein the synthesis of said graft polymer is conducted by means of one of emulsion polymerization and suspension polymerization.

12. The process of claim 1 wherein said reaction mixture from which said graft polymer is synthesized comprises:
A.1 5 to 95 wt. % of at least one vinyl monomer; and
A.2 95 to 5 wt. % of at least one backbone, each of said backbones having a glass transition temperature of <10° C.

13. The process of claim 1 wherein said reaction mixture comprises styrene monomer as a reactive component, and the synthesis of said graft polymer is terminated when the styrene monomer concentration has reached a predetermined concentration value.

14. The process of claim 1 wherein said graft polymer is an ABS graft copolymer, said method further comprising calculating a conversion value of at least one of said reactive components from (i) the concentration value of said reactive component determined in step (d) and (ii) an initial concentration value of said reactive component, and terminating said synthesis reaction when the conversion value of said reactive component has reached a value of 95% to 100%.

15. The process of claim 1 wherein said reaction is terminated by at least one of cooling said reaction mixture and adding a radical interceptor to said reaction mixture.
